(19) United States
(12) Patent Application Publication
(10) Pub. No.: US 2006/0016446 A1
(43) Pub. Date: Jan. 26, 2006

(54) Gas stove with thermoelectric generator

(76) Inventors: Caroline K. Hu, Novi, MI (US); Kevin Z. Hu, Novi, MI (US)

Correspondence Address: HAORAN HU, 23901 BROADMOOR PARK LANE, NOVI, MI, 48374, US

(21) Appl. No.: 10/898,426

(22) Filed: Jul. 24, 2004

(51) Int. Cl. A47J 37/00; F24C 3/00

(52) U.S. Cl. 126/41 R

(57) ABSTRACT

A gas burner generates electricity with waste heat energy. At least one thermoelectric unit is installed underneath the burner cap of the gas burner. Gas flame at the edge of the burner cap creates heat sources (hot side) for the thermoelectric unit. A gas-mixing chamber underneath the thermoelectric unit functions as heat sinks (cold side) for the thermoelectric unit. An insulation plate is inserted in between the thermoelectric unit and the burner cap to control the hot side temperature. The thermoelectric unit generates electricity while the gas burner is in use and the flame heats up the burner cap. The thermoelectric unit connects to an electric circuit and provides electricity to power devices such as electric fans, lights, TVs, battery chargers etc.

### BACKGROUND OF INVENTION

Gas stoves have been used extensively around the world for indoor and outdoor cooking. However, there are many places, where gas cooking is common, without convenient sources of electricity. Gas stoves convert gaseous fuels into thermal energy through gas burners. To utilize waste thermal energy of the gas burners for electricity generation will provide convenience for people's daily life as well as energy savings. Electricity generated by the gas burner can be used to power electric fans, lights, televisions, battery chargers etc.

Major components of a typical gas burner include a gas supply head, a burner base, and a burner cap. The gas supply head provides gaseous fuel, such as natural gas or propane to the burner base. The top surface of the burner base and the bottom surface of the burner cap form a mixing chamber for proper fuel/air mixing. There are slots or holes around the burner head for the formation of flame jets.

Thermoelectric modules have been commercially available for about 30 years. One of such modules is described in U.S. Pat. No. 5,892,656. It has dimensions of 75 mm×75 mm×5 mm and produces 14 Watts at operating temperature difference of 185 C.

U.S. Pat. No. 6,588,419 describes a fireplace appliance with two thermoelectric modules. The thermoelectric modules receive heat energy from the fireplace. An electric fan, powered by the thermoelectric modules, is used to cool heat sink. U.S. Pat. No. 6,053,165 describes a stovepipe thermoelectric generator. Two thermoelectric modules are sandwiched between the stove exhaust pipe and the heat sink.

Both systems mentioned above consume up to 50% of power generated by the thermoelectric modules to cool the heat sink. Therefore, there is a need for a more efficient thermoelectric generator system. The present invention provides a gas burner thermoelectric generator with an internal gas cooling mechanism. This internal gas cooling mechanism eliminates the cooling fans and the heat sink units. Therefore, it significantly improves the overall system efficiency of the thermoelectric generator.

### SUMMARY OF INVENTION

The present invention enables a gas burner to generate electricity with waste thermal energy. The invented gas burner can be installed on gas stoves, such as indoor cooking appliances or outdoor gas grills. At least one thermoelectric unit is installed underneath the burner cap of the gas burner. Gas flame at the edge of the burner cap creates heat source (hot side) for the thermoelectric unit. A gas-mixing chamber underneath the thermoelectric unit functions as heat sink (cold side) for the thermoelectric unit. An insulation plate is inserted in between the thermoelectric unit and the burner cap to control the hot side temperature. The thermoelectric unit generates electricity while the gas burner is in use and the flame heats up the burner cap. The thermoelectric unit connects to an electric circuit and provides electricity to power devices such as electric fans, lights, TVs, battery chargers etc.

### BRIEF DESCRIPTION OF DRAWINGS

FIG. 1 shows operating principle of the thermoelectric modules.

FIG. 2A and 2B show a gas burner with preferred embodiments of the present invention for indoor gas stoves.

FIG. 3A and 3B show other embodiments of the present invention for outdoor gas grills.

FIG. 4A and 4B show a gas burner with preferred embodiments of the present invention for portable gas stoves.

FIG. 5A, 5B, and 5C are cross-section views of thermoelectric modules.

FIG. 6 shows electric power output of gas stoves with thermoelectric generators.

### DETAILED DESCRIPTION

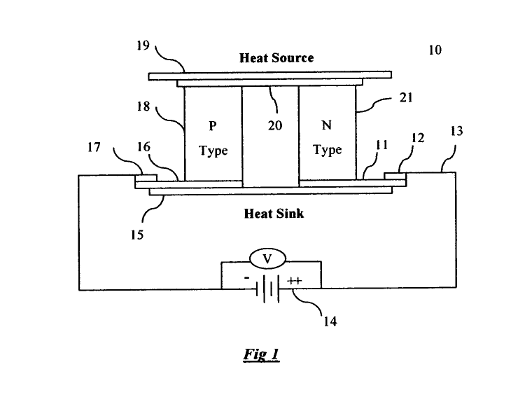

FIG. 1 is a schematic representation of operating principle associated with thermoelectric module 10 in accordance with the present invention. Electrical circuit 13 is a typical circuit associated with thermoelectric elements or thermocouples to convert heat energy into electrical energy. Electrical circuit 13 generally includes two dissimilar or similar materials differing in the type of majority current carrier such as n-type thermoelectric element 21 and p-type thermoelectric element 18. Thermoelectric elements 21 and 18 are typically arranged in an alternating n-type element to p-type element serpentine configuration. In almost all thermoelectric devices, semiconductor materials with these characteristics are connected electrically in series and thermally in parallel. N-type semiconductor materials have more electrons than necessary to complete a perfect molecular lattice structure. P-type semiconductor materials have fewer electrons than necessary to complete a lattice structure. The unbalance of electrons between the n-type semiconductor material and the p-type semiconductor material, coupled with lattice vibrations, transports thermal energy. Bonding joints 11, 16, 20 are attached to electrical interconnects 12 and 17 and to fix thermoelectric elements 18 and 21 between heat source 19 and heat sink 15. Electrical power will be generated if there are temperature differences between heat source 19 and heat sink 15.

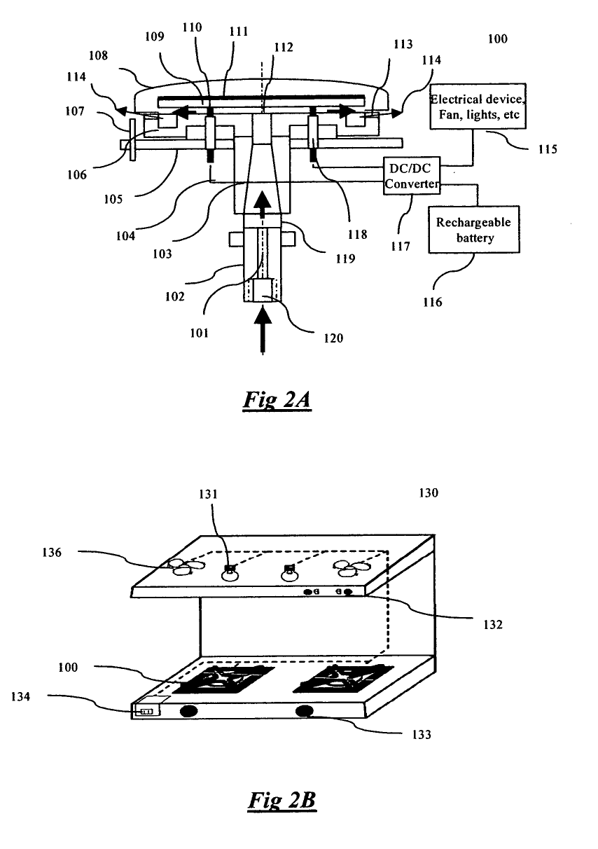

FIG. 2A and 2B disclose a gas stove with thermoelectric power generator 130 according to present invention. The power generation gas stove 130 includes a gas burner 100 with thermoelectric power generation module 109 installed underneath burner cap 108. Fuel gas enters the gas burner through supply connection 120 and orifice 101 to mix with air through ports 119. The orifice 101 is properly designed according to thermal content of the fuel. Burner cap 108 and burner base 106 form a mixing chamber 112. The mixing chamber 112 allows further mixing of fuel and air. Thermoelectric module 109 is mounted underneath the burner cap 108 with thermal insulator 111. Thermal insulator 111 should be properly designed according to the operating temperature range of thermal electric module 109. The burner base 106 was designed to have outward slots or holes 113. Igniter 107 can be used to ignite the fuel/air mixture to form sustainable flame jets 114. The burner cap, heated up by flame jets 114, will function as heat sources for thermoelectric modules 109. Another side of the thermoelectric modules 109 faces the fuel/air mixtures of the mixing chamber 112. The fuel/air mixture, which maintains almost constant temperature, functions as heat sinks for thermoelectric module 109 to create temperature difference across the thermoelectric modules for electricity generation. Thermoelectric module 109 can be the conventional Bismuth Telluride based thermoelectric module or nano-composite semiconductors, such as, SiGe/Si composite, with higher thermal conversion efficiency. Typically, the output voltage of thermoelectric modules is less than 12V, and a DC/DC voltage converter is needed to increase the output voltage to a proper range. Thermoelectric module 109 connects to a DC/DC converter 117 through electric outlets 118 and connecting wires 104. Electricity generated by thermoelectric modules 109 will power electric devices 115, 131, 136, battery charger 116 etc.

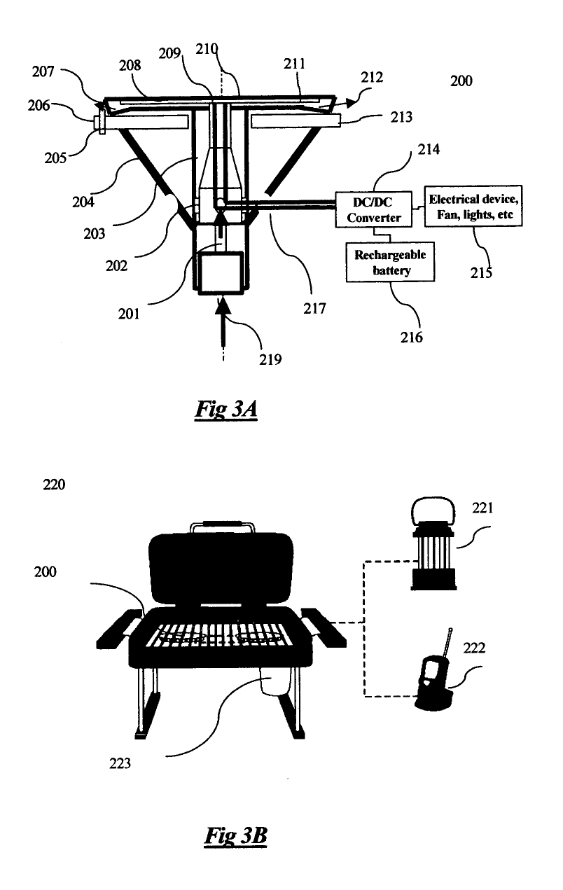

A thermoelectric gas burner for portable grills is shown in FIG. 3A and FIG. 3B. FIG. 3A shows gas burner 200 with thermoelectric modules 211 installed inside burner head 210. The burner head 210 is installed on top of burner base 213 with igniter 206. A conical shaped windshield 204 supports the burner base 213 for outdoor usages. Fuel inlet 219 connects to gas tank 223 as illustrated in FIG. 3B. An orifice 201 is designed according to heating content of the fuels.

The mixture supply tube 203 has air inlet holes 202 to allow proper fuel/air mixing. The burner head 210 has a mixture chamber 207 and fuel/air discharge holes for proper flame jet 212 distributions. While the grill is in use, the top surface 208 of the burner head 210 will be heated by the flame jets 212 and functions as heat source for the thermoelectric modules 211. The fuel/air mixture in the mixing chamber 207 functions as heat sink to carry the heat away. The thermoelectric modules 211 have two outlets 209 and connecting wires 217 connected to a DC/DC converter 214. Electric power generated by thermoelectric modules 211 can be used for to power electric devices 215, such as lights 221 or battery charger 222.

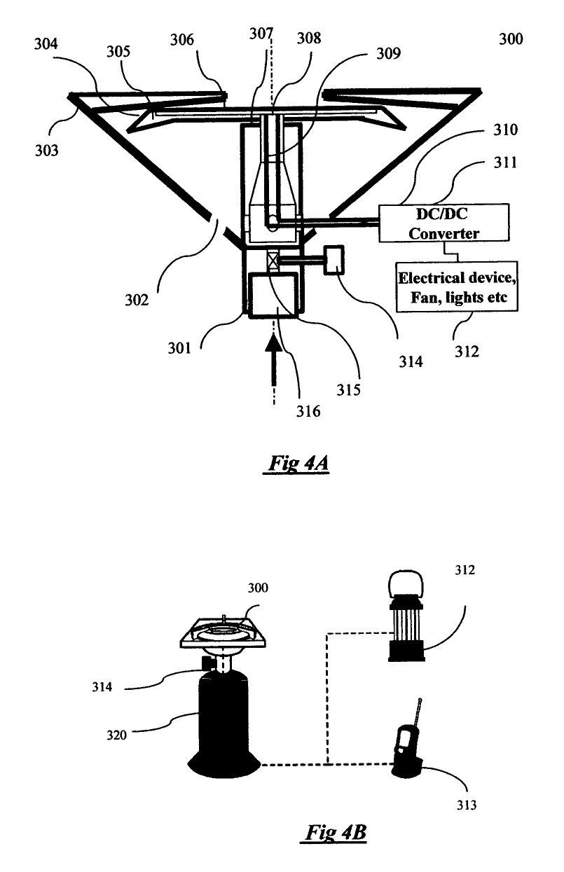

FIG. 4A and 4B show a gas stove with thermoelectric generators for camping and other outdoor usages. Gas burner 300 has burner head 306, in which, thermoelectric modules 308 are installed underneath the top surface of the burner head 306. The enclosed burner head 306 forms a fuel/air mixture chamber 305, which functions as a heat sink for thermoelectric modules 308. Fuel, from fuel tank 320, through inlet port 316, orifice 315, and valve 314, flows to mixing chamber 305. Windshield 303 is designed for outdoor cooking. Two electric outlets 309 connect the thermoelectric modules 308 to DC/DC converter 311 through wires 310. DC/DC converter 311 converts the power generated by the thermoelectric modules to proper voltage for powering electric devices 312 and 313.

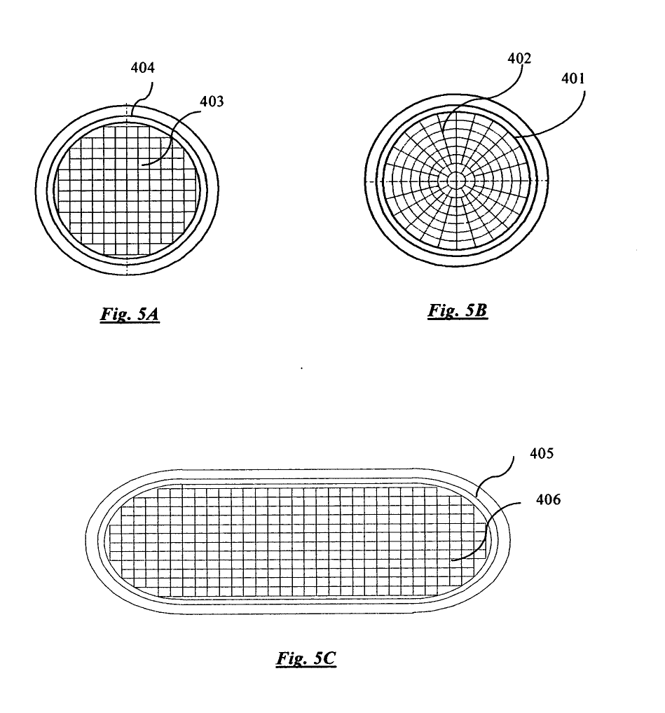

The thermoelectric module should be designed for maximizing the electric power generation. Examples of thermoelectric module layout are shown in FIG. 5A, 5B, and 5C. FIG. 5A shows a square thermoelectric module 403 mounted on a round burner cap 404. FIG. 5B shows an alternate layout of thermoelectric modules 402 mounted on a round burner cap 401. An oval shaped burner cap with square shaped thermoelectric modules is shown in FIG. 5C.

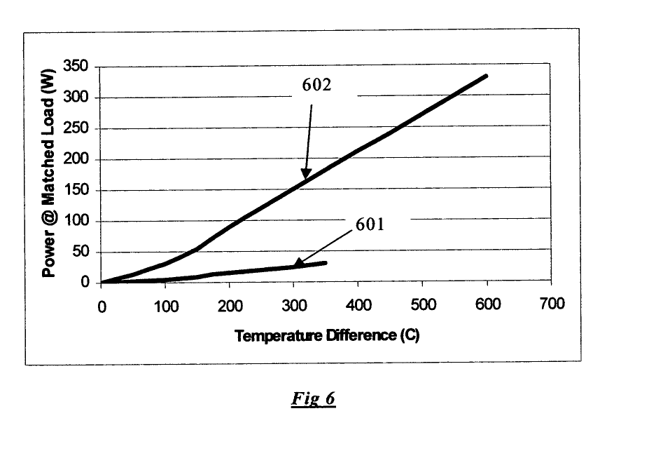

Power outputs of typical gas burner thermoelectric generators are shown in FIG. 6. Line 601 shows electrical power output by a commercially available thermoelectric module mounted on a gas burner with a diameter of 100 mm. Line 602 shows a simulated power output of the same size gas burner with nano composite thermoelectric modules.

Although particular systems are disclosed, it will be apparent to persons skilled in the art that modifications may be made without departing from the scope of the invention. All such modifications as well as equivalents are thereof to be included within the scope of the following claims.

What is claimed is:

1. A gas burner with thermoelectric generator comprising: a burner base, a burner cap, a burner head, and thermoelectric modules;
said burner base having at least one fuel supply passage, and having installation connections on a chassis of cooking appliances;
said burner cap having slots or holes for the main flame jets;
said burner head having at least one thermoelectric module installed underneath the bottom surface of the burner cap;
said thermoelectric modules incorporated in the burner head in said gas burner for generating electric power.

2. Said thermoelectric module as in claim 1 comprises: a hot side is in contact with the burner cap, an insulator is placed in between the burner cap and the thermoelectric modules for controlling the hot side temperature; a cold side faces fuel/air mixture. The fuel/air mixture functions as heat sink for the thermoelectric modules.

3. A gas burner thermoelectric generator as in claim 1, wherein said at least one thermoelectric module comprises: a plurality of p-type thermoelectric elements, a plurality of n-type thermoelectric elements, said p-type and said n-type thermoelectric elements being connected electrically in series and thermally in parallel.

4. The said thermoelectric modules in claim 1 can be designed in different shapes for maximizing power output.

5. A gas burner according to claim 1 wherein said burner head has electric outlets connected to the said thermoelectric modules and to a voltage converter.

6. Electricity generated by the said thermoelectric modules in claim 1, powers electric devices, such as fans, lights, TVs, battery charger etc.

7. A gas burner thermoelectric generator comprising: a burner base, a burner head, and thermoelectric modules;
said burner base having at least one fuel supply passage;
said burner head having multiple holes or slots for the main flame jets, and having a fuel/air mixing chamber functions as heat sink for the thermoelectric modules;
said thermoelectric modules installed underneath the top surface of the burner head in said gas burner for generating electric power.

8. Said thermoelectric modules as in claim 7 comprising: a plurality of p-type thermoelectric elements, and a plurality of n-type thermoelectric elements, said p-type and said n-type thermoelectric elements are being build with super lattice nano-composite materials and are being position in a multiplayer quantum well structure.

9. Said thermoelectric modules as in claim 7 comprising: a hot side which is in contact with the top surface of the burner head, an insulator is placed in between the burner head and the thermoelectric modules for controlling the hot side temperature, a cold side faces the mixing chamber of the burner head. The mixing chamber of the burner head functions as heat sink for the thermoelectric modules.

10. A gas burner assembly according to claim 7 wherein said burner head has electric outlets from the said thermoelectric modules.

11. The said electric outlets in claim 7 are connected to a DC/DC converter.

12. The said electric outlets in claim 7 is connected to electric devices, such as fans, lights, portable thermoelectric cooler, battery charger, etc.
